(19) United States
(12) Patent Application Publication
(10) Pub. No.: US 2026/0322244 A1
(43) Pub. Date: Oct. 15, 2026

(54) SWITCHING CONTROL CIRCUIT AND POWER SUPPLY CIRCUIT

(71) Applicant: FUJI ELECTRIC CO., LTD., Kawasaki-shi (JP)

(72) Inventor: Ryuji YAMADA, Tokyo (JP)

(73) Assignee: FUJI ELECTRIC CO., LTD., Kawasaki-shi (JP)

(21) Appl. No.: 19/465,125

(22) Filed: Jan. 30, 2026

(30) Foreign Application Priority Data
Mar. 21, 2025 (JP) 2025-046456

(51) Int. Cl. H02M 1/08; H02M 1/00; H02M 1/14; H02M 1/42

(52) U.S. Cl. CPC H02M 1/08; H02M 1/0009; H02M 1/14; H02M 1/42

(57) ABSTRACT

A switching control circuit for a power supply circuit including a first inductor, a transistor controlling an inductor current flowing through the first inductor, and a second inductor. The switching control circuit includes: a detection circuit configured to detect that the inductor current reaches a predetermined value, based on a voltage generated across the second inductor; and a signal output circuit configured to output a drive signal to turn on the transistor, in response to the detection circuit detecting that the inductor current reaches the predetermined value, and output the drive signal to turn off the transistor in response to a time period corresponding to the output voltage having elapsed. The second inductor is configured to be in an unsaturated state when the inductor current is within a predetermined range including the predetermined value, and in a saturated state when the inductor current is outside the predetermined range.

### CROSS-REFERENCE TO RELATED APPLICATION

This application claims priority pursuant to 35 U.S.C. § 119 from Japanese Patent Application No. 2025-046456, filed on Mar. 21, 2025, the entirety of which is incorporated herein by reference.

### BACKGROUND

### Technical Field

The present invention relates to a switching control circuit and a power supply circuit.

### Related Art

Some power factor correction circuits operate in a critical mode, in which the power factor correction circuit turns on a transistor when an inductor current reaches a predetermined value (for example, zero). Further, in some cases, a transformer including a main coil and an auxiliary coil is used to detect that an inductor current flowing through the main coil reaches a predetermined value based on a voltage across the auxiliary coil (for example, Japanese Patent Application Publication Nos. 2021-044969 and 2022-041912 and Japanese Patent No. 7501267).

However, in some cases, it is difficult to detect, with high accuracy, that the inductor current flowing through the main coil reaches the predetermined value based on the voltage across the auxiliary coil.

### SUMMARY

An aspect of the present disclosure is a switching control circuit for a power supply circuit that generates an output voltage at a target level from an input voltage inputted thereto, the power supply circuit including a first inductor configured to receive a voltage corresponding to an input voltage, a transistor configured to control an inductor current flowing through the first inductor, and a second inductor configured to have a current flowing therethrough, the switching control circuit being configured to switch the transistor of the power supply circuit, the switching control circuit comprising: a detection circuit configured to detect that the inductor current reaches a predetermined value, based on a voltage generated across the second inductor; and a signal output circuit configured to output a drive signal to turn on the transistor, in response to the detection circuit detecting that the inductor current reaches the predetermined value, and output the drive signal to turn off the transistor, in response to a time period corresponding to the output voltage having elapsed, the second inductor being configured to be in an unsaturated state when the inductor current is within a predetermined range including the predetermined value, and be in a saturated state when the inductor current is outside the predetermined range.

An aspect of the present disclosure is a power supply circuit configured to generate an output voltage at a target level from an input voltage inputted thereto, comprising: a first inductor configured to receive a voltage corresponding to the input voltage;
a transistor configured to control an inductor current flowing through the first inductor; a second inductor configured to have a current flowing therethrough; a switching control circuit configured to switch the transistor, the switching control circuit including a detection circuit configured to detect that the inductor current reaches a predetermined value, based on a voltage generated across the second inductor; and a signal output circuit configured to output a drive signal to turn on the transistor in response to the detection circuit detecting that the inductor current reaches the predetermined value, and output the drive signal to turn off the transistor in response to a time period corresponding to the output voltage having elapsed, the second inductor being configured to be in an unsaturated state when the inductor current is within a predetermined range including the predetermined value, and be in a saturated state when the inductor current is outside the predetermined range.

### BRIEF DESCRIPTION OF THE DRAWINGS

FIG. 1 is a diagram illustrating an example configuration of an AC-DC converter 10.

FIG. 2 is a diagram illustrating an example configuration of a power factor correction IC 26.

FIG. 3 is a diagram illustrating an example configuration of a digital circuit 42.

FIG. 4 is a diagram illustrating an example configuration of a detection circuit 41.

FIG. 5 is a diagram illustrating an example of an inductance value versus a current of a saturable inductor 22.

FIG. 6 is a diagram illustrating an example of a state change of the saturable inductor 22 corresponding to an inductor current IL.

FIG. 7 is a diagram illustrating an example of a change in a voltage Vsat corresponding to an estimated value Vr_est.

FIG. 8 is a diagram illustrating an example configuration of an AC-DC converter 12.

FIG. 9 is a diagram illustrating an example configuration of a detection circuit 44.

FIG. 10 is a diagram illustrating an example configuration of an AC-DC converter 13.

FIG. 11 is a diagram illustrating an example configuration of a power factor correction IC 30.

FIG. 12 is a diagram illustrating an example configuration of a digital circuit 48.

FIG. 13 is a diagram illustrating an example of an embodiment using a DSP.

### DETAILED DESCRIPTION

At least the following matters will be apparent from description of the present specification and the attached drawings. Hereinafter, identical or equivalent components, members, and the like illustrated in the drawings are denoted by the same reference numerals, and a repeated description thereof may be omitted as appropriate.

### Embodiment

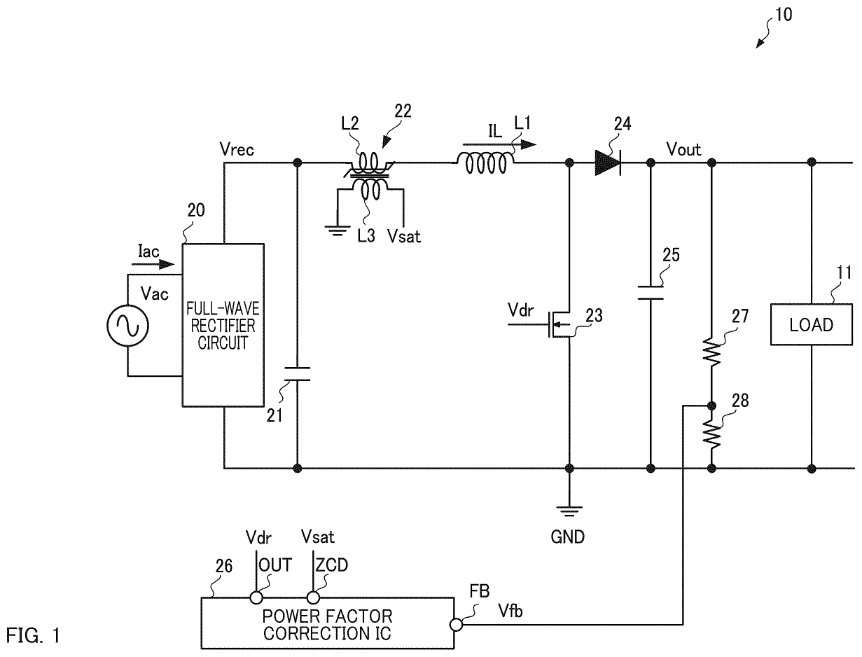

FIG. 1 is a diagram illustrating an example configuration of an AC-DC converter 10, which is an embodiment of the present invention. The AC-DC converter 10 is a boost chopper power supply circuit configured to generate an output voltage Vout at a target level from an AC voltage Vac of a commercial power supply. The AC-DC converter 10 applies the output voltage Vout to a load 11, thereby supplying power.

The AC-DC converter 10 includes a full-wave rectifier circuit 20, capacitors 21 and 25, a saturable inductor 22, an inductor L1, an NMOS transistor 23, a diode 24, a power factor correction IC 26, and resistors 27 and 28.

The full-wave rectifier circuit 20 full-wave rectifies a predetermined AC voltage Vac inputted thereto and applies the resultant voltage as an input voltage Vrec to the capacitor 21 and the saturable inductor 22. The AC voltage Vac is, for example, a voltage with an effective value of 140 to 240 V and a frequency of 50 to 60 Hz. In the following embodiment, a voltage is basically a potential difference from a reference point (GND in FIG. 1), but the AC voltage Vac indicates a voltage between terminals.

The capacitor 21 smooths the input voltage Vrec, whereas the capacitor 25 configures a boost chopper circuit together with the inductor L1, the NMOS transistor 23, and the diode 24. Therefore, a charging voltage of the capacitor 25 is a DC output voltage Vout.

The saturable inductor 22 indicates that an inductor current IL reaches a predetermined value (for example, zero amperes). Specifically, the saturable inductor 22 is in an unsaturated state when the inductor current IL is within a predetermined range including the predetermined value, and is in a saturated state when the inductor current IL is outside the predetermined range, which will be described later in detail. Thus, when the NMOS transistor 23 is turned off and the inductor current IL decreases to bring the current value within the predetermined range, a voltage corresponding to a differential voltage between the output voltage Vout and the input voltage Vrec is generated across both ends of the saturable inductor 22.

The saturable inductor 22 includes a coil L2 and a coil L3 magnetically coupled to the coil L2. A voltage corresponding to the input voltage Vrec is applied to a first terminal of the coil L2 and a second terminal of the coil L2 is coupled to the inductor L1. Therefore, a voltage according to the voltage generated across the coil L2 is generated across the coil L3. Here, the saturable inductor 22 is formed of an inexpensive ferrite bead.

The saturable inductor 22 configures a voltage divider circuit together with the inductor L1. When the NMOS transistor 23 is off, the saturable inductor 22 generates a voltage Vsat at a coupling point thereof, the voltage Vsat obtained by dividing the differential voltage between the output voltage Vout and the input voltage Vrec. The voltage division ratio of the saturable inductor 22 and the inductor L1 is set to a voltage division ratio that allows the power factor correction IC 26 to detect the voltage Vsat. The coil L2 corresponds to a “second inductor” and the coil L3 corresponds to a “third inductor”.

The NMOS transistor 23 is a switching device to control the power to be supplied to the load 11 of the AC-DC converter 10 by controlling the inductor current IL flowing through the inductor L1. The NMOS transistor 23 is an N-type metal oxide semiconductor (MOS) transistor in this embodiment, but, for example, a bipolar transistor, an insulated gate bipolar transistor (IGBT), or the like may be used instead.

A gate electrode of the NMOS transistor 23 is coupled to a terminal OUT of the power factor correction IC 26. The inductor L1 corresponds to a “first inductor”.

The power factor correction IC 26 is an integrated circuit configured to switch the NMOS transistor 23 such that the level of the output voltage Vout reaches a target level (for example, 400 V) while correcting the power factor of the AC-DC converter 10. Specifically, the power factor correction IC 26 drives the NMOS transistor 23 based on the inductor current IL and the output voltage Vout. As will be described later in detail, the power factor correction IC 26 is provided with terminals FB, OUT, and ZCD. In this embodiment, terminals other than the terminal FB and the like of the power factor correction IC 26 are omitted for convenience. The power factor correction IC 26 corresponds to a “switching control circuit”.

The resistors 27 and 28 configure a voltage divider circuit configured to divide the output voltage Vout and generate a feedback voltage Vfb to be used for switching the NMOS transistor 23. The feedback voltage Vfb generated at a node at which the resistors 27 and 28 are coupled to each other is applied to the terminal FB.

### Configuration of Power Factor Correction IC 26

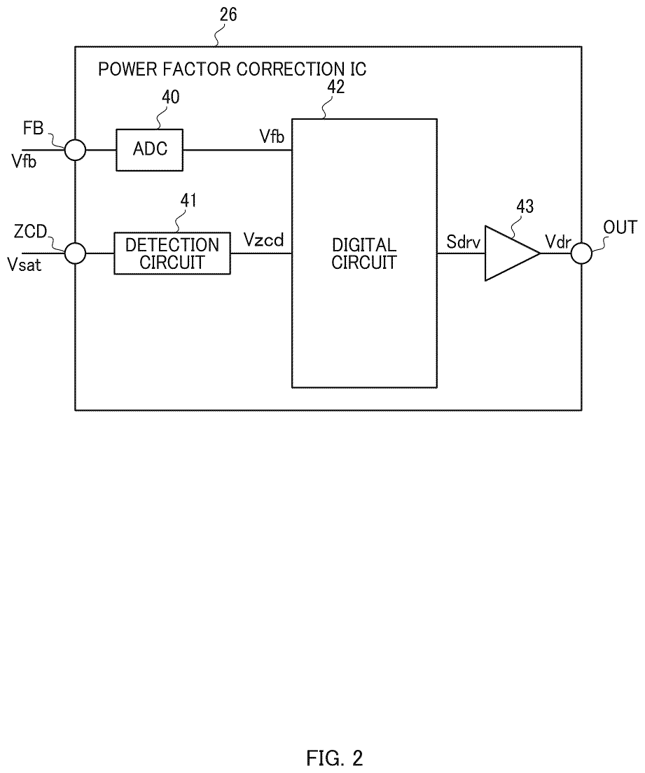

FIG. 2 is a diagram illustrating an example configuration of the power factor correction IC 26. The power factor correction IC 26 switches the NMOS transistor 23. The power factor correction IC 26 includes an analog-to-digital converter circuit (ADC) 40, a detection circuit 41, a digital circuit 42, and a driver circuit 43.

The analog-to-digital converter circuit 40 converts the feedback voltage Vfb into a digital value. Here, the digitized feedback voltage Vfb will be also referred to as the feedback voltage Vfb for convenience.

The detection circuit 41 detects that the inductor current IL reaches the predetermined value, based on the voltage generated across the coil L3 in response to the saturable inductor 22 turning into the unsaturated state. Specifically, based on a situation where the voltage Vsat reaches a predetermined level, the detection circuit 41 outputs a signal Vzcd indicating the detection that the inductor current IL reaches the predetermined value. The detection circuit 41 will be described later in detail.

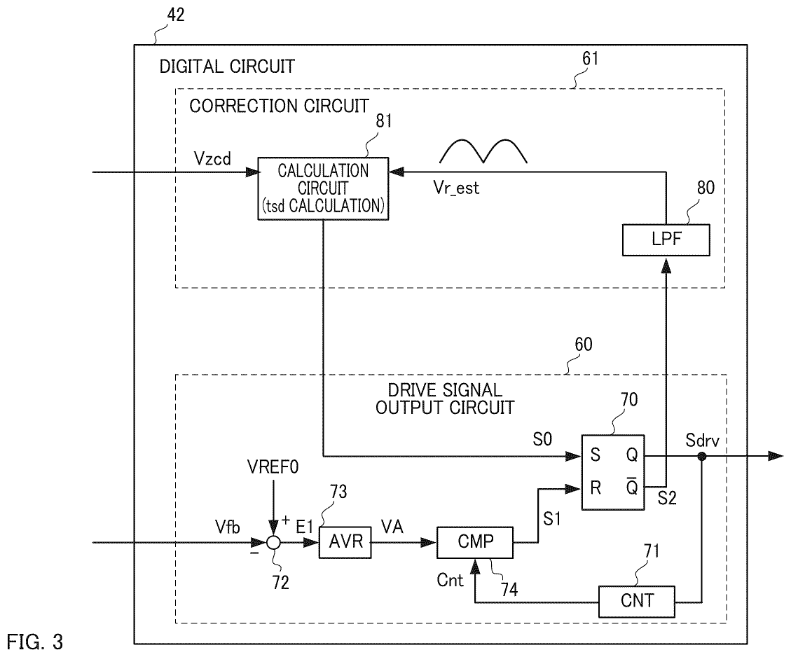

FIG. 3 is a diagram illustrating an example configuration of the digital circuit 42. The digital circuit 42 outputs a drive signal Sdrv to switch the NMOS transistor 23 based on the feedback voltage Vfb and the signal Vzcd.

Specifically, the digital circuit 42 outputs the drive signal Sdrv to turn on the NMOS transistor 23 in response to the detection circuit 41 detecting that the inductor current IL reaches the predetermined value. Then, the digital circuit 42 outputs the drive signal Sdrv to turn off the NMOS transistor 23 when a time period corresponding to the output voltage (i.e., the feedback voltage Vfb) has elapsed. The digital circuit 42 includes a drive signal output circuit 60 and a correction circuit 61. The digital circuit 42 corresponds to a “signal output circuit”.

The drive signal output circuit 60 outputs the drive signal Sdrv to switch the NMOS transistor 23 based on the feedback voltage Vfb and a signal S0. specifically, the drive signal output circuit 60 outputs the drive signal Sdrv to turn on the NMOS transistor 23 in response to the signal S0 at a high level (hereinafter referred to as high or high level) being inputted to the drive signal output circuit 60. Then, the drive signal output circuit 60 outputs the drive signal Sdrv to turn off the NMOS transistor 23 in response to the time period corresponding to the output voltage (i.e., the feedback voltage Vfb) having elapsed.

The drive signal output circuit 60 includes an SR flip-flop 70, a counter 71, a subtractor 72, a voltage regulator (AVR) 73, and a comparator 74.

In response to the signal S0 indicative of the timing when the inductor current IL reaches the predetermined value (i.e., high signal S0) being inputted to the SR flip-flop 70, the SR flip-flop 70 outputs the high drive signal Sdrv, thereby turning on the NMOS transistor 23. On the other hand, in response to a high signal S1 (described later) being inputted to the SR flip-flop 70, the SR flip-flop 70 outputs the drive signal Sdrv at a low level (hereinafter referred to as low or low level), thereby turning off the NMOS transistor 23.

The counter 71 counts a time period during which the high drive signal Sdrv is outputted, and outputs a count value Cnt. Then, the counter 71 is reset in response to the low drive signal Sdrv being outputted.

The subtractor 72 calculates an error E1 between a reference voltage VREF0 and the feedback voltage Vfb by subtracting the feedback voltage Vfb from the reference voltage VREF0.

In response to the error E1, the voltage regulator 73 outputs a command voltage VA to equalize the level of the feedback voltage Vfb to the level of the reference voltage VREF0. The subtractor 72 and the voltage regulator 73 correspond to, for example, a so-called error amplifier circuit to perform amplification, integration, or the like of the error E1.

The comparator 74 compares the count value Cnt and the command voltage VA. Specifically, the comparator 74 outputs the high signal S1 when the count value Cnt is equal to a numeric value corresponding to the command voltage VA. As a result, the time period during which the high drive signal Sdrv is outputted is the time period corresponding to the feedback voltage Vfb.

The correction circuit 61 corrects the timing when the high signal Vzcd (i.e., the result of the detection of the detection circuit 41) is inputted based on the voltage level of the input voltage Vrec, and outputs the signal S0 indicating the timing when the inductor current IL actually reaches the predetermined value. This correction, as will be described later in detail, is to reduce a timing error that occurs when the saturable inductor 22 is used to detect the inductor current IL. The correction circuit 61 includes a low-pass filter (LPF) 80 and a calculation circuit 81.

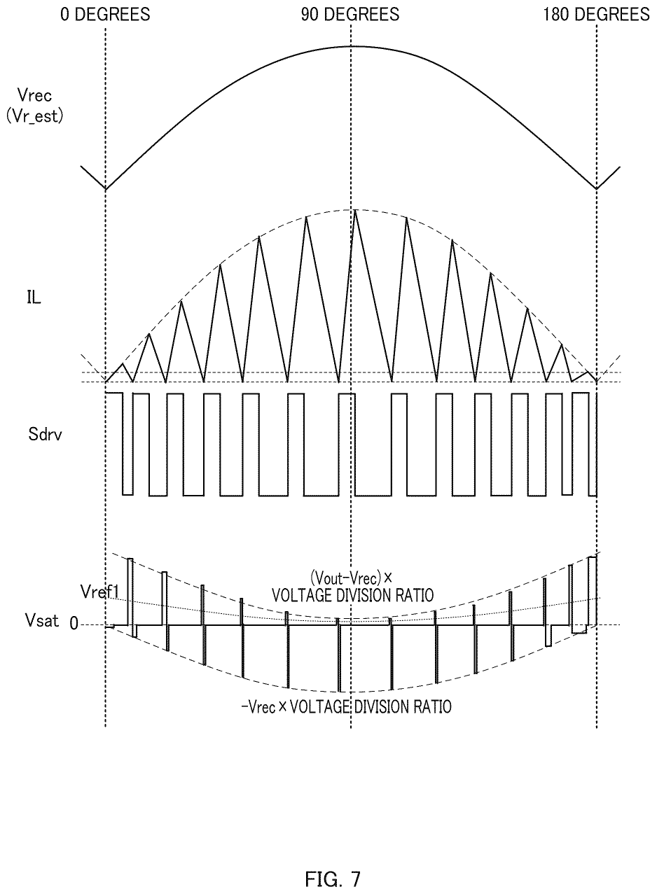

The low-pass filter 80 performs averaging process to extract the average value of a signal S2, which is a Q-bar output of the SR flip-flop 70, and outputs a signal Vr_est. As a result, the signal Vr_est is a signal according to the voltage level of the input voltage Vrec, and also is a signal indicating an off-duty α of the NMOS transistor 23, as will be described in detail later with reference to FIG. 7. Here, the extraction of the average value of the signal S2 may involve integration of values of the signal S2. The signal Vr_est corresponds to a “level signal”.

When the saturable inductor 22 enters the unsaturated state and the detection circuit 41 outputs the signal Vzcd, the calculation circuit 81 calculates an error tsd from the timing when the signal Vzcd is outputted to the timing when the inductor current IL reaches the predetermined value, and corrects the timing when the NMOS transistor 23 is to be turned on.

The calculation circuit 81 calculates the timing error tsd in accordance with the following manner based on an inductance value L1 of the inductor L1, a current value Isat that is the greatest value in a predetermined range where the saturable inductor 22 is in the unsaturated state, the output voltage Vout, and the signal Vr_est (i.e., the off-duty α).

tsd=L1×Isat/(Vout−Vrec) =L1×Isat/(Vout(1−α)) . . . Expression (1)

Here, since the inductance value L1, the current value Isat, and the output voltage Vout in Expression (1) are known, the timing error can be corrected if the signal Vr_est indicating the off-duty α of the NMOS transistor 23 is obtained.

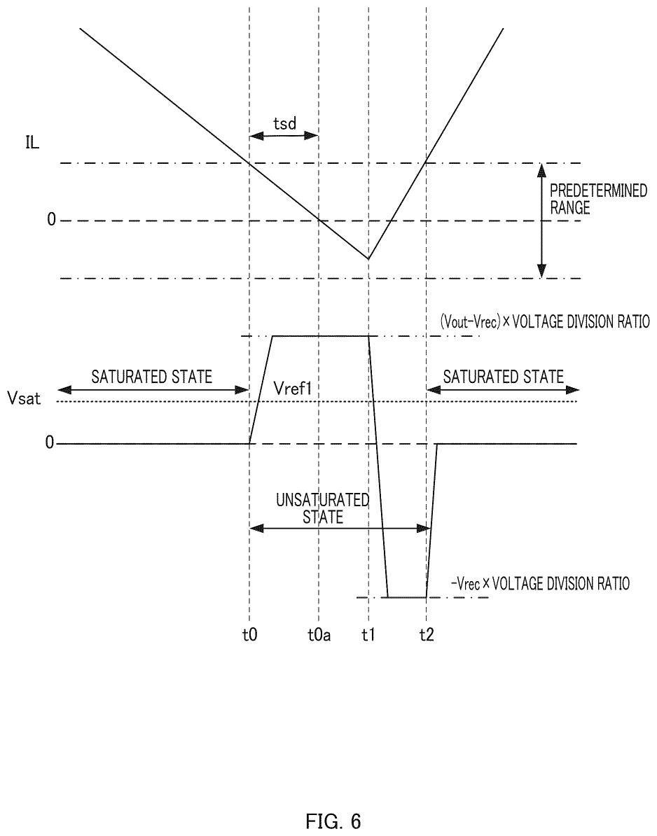

Then, the calculation circuit 81 corrects the timing when the signal Vzcd is outputted based on the error tsd, and outputs the signal S0 to the SR flip-flop 70, the signal S0 indicating the timing when the inductor current IL reaches the predetermined value (i.e., the timing when the NMOS transistor 23 is to be turned on). Note that, the timing when the NMOS transistor 23 is actually turned on is delayed from the timing when the inductor current IL will reach the predetermined value (for example, time t0a) due to influence of a circuit delay and the like, as illustrated at time t1 in FIG. 6 described later. Here, the calculation circuit 81 may correct the timing when the NMOS transistor 23 is turned on, in consideration of the influence of a circuit delay and the like (for example, a time period from time t0a to time t1).

The driver circuit 43 in FIG. 2 outputs a drive voltage Vdr for switching the NMOS transistor 23 based on the drive signal Sdrv.

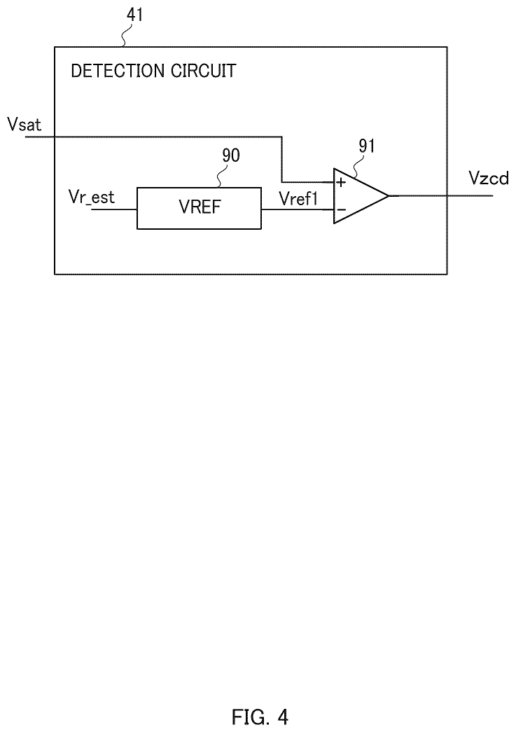

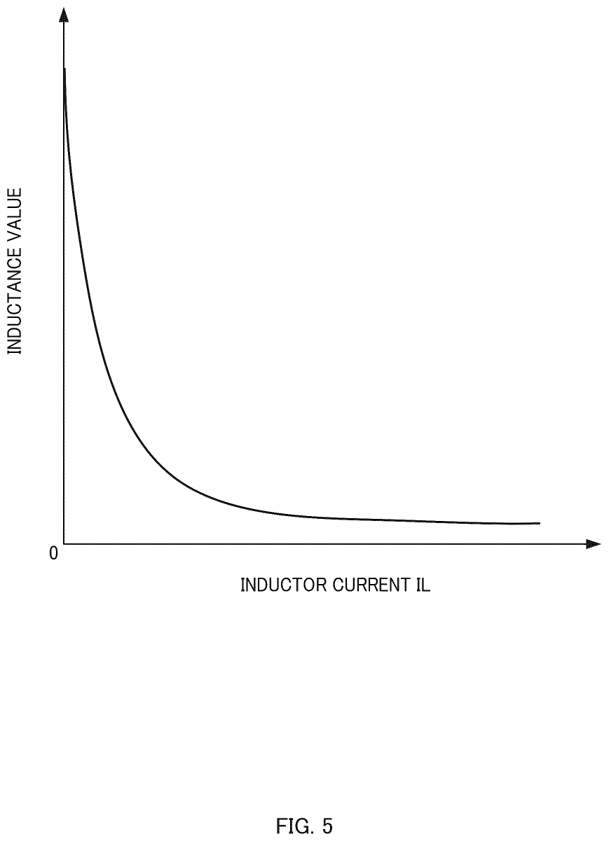

FIG. 4 is a diagram illustrating an example configuration of the detection circuit 41, and FIG. 5 is a graph illustrating an example of an inductance value versus a current of the saturable inductor 22. FIG. 6 is a diagram illustrating an example of a state change of the saturable inductor 22 corresponding to the inductor current IL, and FIG. 7 is a diagram illustrating an example of a change in the voltage Vsat according to an estimated value Vr_est.

The detection circuit 41 detects that the inductor current IL reaches the predetermined value, based on the voltage generated across the coil L3 in response to the saturable inductor 22 entering the unsaturated state. Specifically, the detection circuit 41 compares a reference voltage Vref1 corresponding to the signal Vr_est with the voltage Vsat and outputs the signal Vzcd. The detection circuit 41 includes a reference voltage circuit 90 and a comparator 91.

The reference voltage circuit 90 outputs the reference voltage Vref1 indicating that the inductor current IL reaches the predetermined value, and changes the reference voltage Vref1 according to the voltage level of the input voltage Vrec.

The comparator 91 detects that the inductor current IL reaches the predetermined value, based on the voltage Vsat (i.e., the voltage generated across the coil L2) and the reference voltage Vref1.

Also as illustrated in FIG. 5, an inductance value L2 of the coil L2 changes according to the magnitude of the inductor current IL flowing through the coil L2. For this reason, when the inductor current IL is within the predetermined range including the predetermined value, the saturable inductor 22 is in the unsaturated state (the inductance value L2 increases), and the voltage Vsat generated across the coil L3 increases in magnitude. On the other hand, when the inductor current IL is outside the predetermined range, the saturable inductor 22 is in the saturated state (the inductance value L2 decreases), the voltage Vsat generated across the coil L3 decreases in magnitude and the voltage is no longer generated across the coil L3. Here, when the inductor current IL is zero ampere, the inductance value L2 is a finite value.

Moreover, as illustrated in FIG. 6, when the inductor current IL decreases and falls within the predetermined range at time t0, the voltage Vsat obtained by multiplying (Vout−Vrec) by the voltage division ratio is generated across the coil L3. On the other hand, when the inductor current increases within the predetermined range from time t1, the voltage Vsat obtained by multiplying −Vrec by the voltage division ratio is generated across the coil L3. Then, when the inductor current IL falls outside the predetermined range at time t2, no voltage is generated across the coil L3. Here, the voltage division ratio is a voltage division ratio of the voltage divider circuit between the inductor L1 and the coil L2.

If the NMOS transistor 23 is turned on at time t0, the NMOS transistor 23 is turned on at the timing when the inductor current IL is yet to actually reach the predetermined value. To avoid this, the calculation circuit 81 calculates the error tsd, and at time t0a, which is delayed from time t0 by the error tsd, outputs the high signal S0 and turns on the NMOS transistor 23. However, due to the influence of a circuit delay and the like, the NMOS transistor 23 is actually turned on at time t1 and the inductor current IL starts to increase from time t1.

In addition, as illustrated in FIG. 7, the voltage Vsat changes according to a component of the input voltage Vrec. Accordingly, when the reference voltage Vref1 is not changed according to the signal Vr_est, the level of the reference voltage Vref1, if it is set in consideration with the voltage Vsat at a high phase angle, is set to a low level.

If the level of the reference voltage Vref1 is set to the low level as described above, noise will exert great influence on the detection that the inductor current IL reaches the predetermined value. For this reason, the reference voltage circuit 90 performs control such that the reference voltage Vref1 is high when the phase angle is low and is low when the phase angle is high.

Here, the “high” phase angle of the input voltage Vrec means that the angle, expressed as the phase angle of the AC voltage Vac, is in a range of, for example, 90±10+180n degrees, that is, in a range of (80 to 100)+180n degrees. On the other hand, the “low” phase angle of the input voltage Vrec means that the phase angle is in a range of, for example, 0±10+180n degrees, that is, in a range of (−10 to +10)+180n degrees. Here, n is an integer.

Here, description will be given of the reason why the low-pass filter 80 integrates the signal S2, which is the Q-bar output of the SR flip-flop 70, to obtain the signal Vr_est in FIG. 3. As illustrated in FIG. 7, when the output voltage Vout is maintained at the target level and the ON-periods of the NMOS transistor 23 are approximately constant, the peak value of the inductor current IL increases as the phase angle (or the voltage level) of the input voltage Vrec becomes higher and decreases as the phase angle of the input voltage Vrec becomes lower.

Meanwhile, a time period from when the NMOS transistor 23 is turned off to when the inductor current IL stops flowing increases as the phase angle of the input voltage Vrec becomes higher and decreases as the phase angle of the input voltage Vrec becomes lower. Accordingly, when the AC-DC converter 10 operates in the critical mode, the signal Vr_est becomes higher as the phase angle of the input voltage Vrec becomes higher and becomes lower as the phase angle of the input voltage Vrec becomes small. As a result, the signal Vr_est is a signal based on an AC component (or the voltage level) of the input voltage Vrec.

In this way, it is possible to provide a switching control circuit capable of accurately detecting a timing when the inductor current reaches a predetermined value.

### Modifications

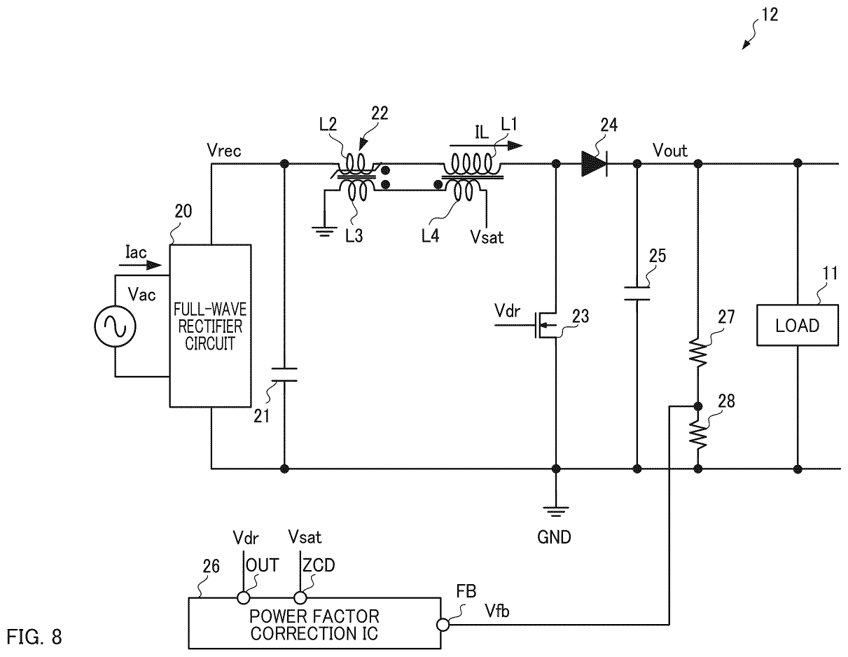

FIG. 8 is a diagram illustrating an example configuration of an AC-DC converter 12. In the AC-DC converter 12, a saturable inductor 22 includes a coil L2, and a coil L3 across which a voltage in the same direction as in the coil L2 is generated when a current flowing through the coil L2 decreases.

In addition, in the AC-DC converter 12, an inductor L1 is provided with a coil L4 magnetically coupled to the inductor L1. The coil L4 is provided such that a voltage in a direction opposite to a direction of a voltage applied to the inductor L1 is generated when a current flowing through the inductor L1 decreases. The coil L4 is wound such that the voltage that is approximately the same as or slightly smaller than a voltage depending on the voltage division ratio between the inductor L1 and the coil L2 can be generated. Accordingly, in general, the coil L4 illustrated in FIG. 8 is not used for a method of determining that the inductor current IL reaches the predetermined value based on the voltage generated across the coil L4, but is only used for correction to improve accuracy, in designing the coil L4, it is unnecessary to consider so precisely the number of turns and the like. Therefore, even if the accuracy of the voltage generated across the coil L4 itself is somewhat low, there is no problem with the coil L4 illustrated in FIG. 8. The coil L4 corresponds to a “fourth inductor”.

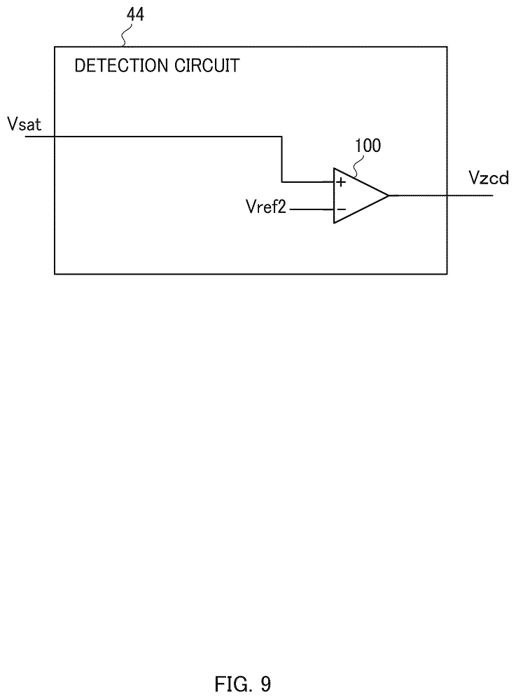

The coils L3 and L4 are coupled to each other as illustrated in FIG. 8. As illustrated in FIG. 9, a detection circuit 44, which is a modification of the detection circuit 41, detects that the inductor current IL reaches the predetermined value based on a difference between the voltage generated across the coil L2 (i.e., the coil L3) and the voltage generated across the inductor L1 (i.e., the coil L4). Specifically, based on the voltage Vsat (i.e., the voltage across both ends of the coils L3 and L4 coupled in series), the detection circuit 44 compares the voltage Vsat with a reference voltage Vref2, thereby detecting that the inductor current IL reaches the predetermined value.

Here, the voltage Vsat is a negative voltage when the coil L2 is in the saturated state or the inductance value is smaller than in the unsaturated state. On the other hand, the voltage Vsat is a zero voltage or a positive voltage when the coil L2 is in the unsaturated state.

Thus, if the reference voltage Vref2 is set to approximately zero volt, the detection circuit 44 is enabled to detect that the inductor current IL reaches the predetermined value. Further, even though the voltage Vsat is generated when the voltage applied to the inductor L1 (for example, Vout−Vrec) is large, the voltage Vsat is a negative voltage if the inductance value L2 of the saturable inductor 22 is small as compared with a predetermined voltage division ratio, thereby preventing the detection circuit 44 from erroneously detecting that the inductor current IL reaches the predetermined value.

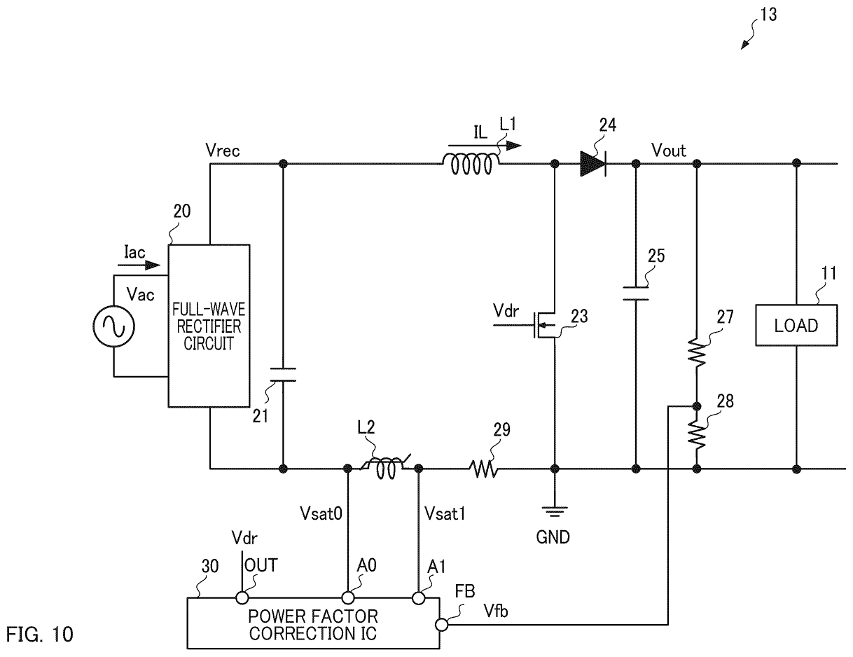

FIG. 10 is a diagram illustrating an example configuration of an AC-DC converter 13. In the AC-DC converter 13, a coil L2 of a saturable inductor 22 is provided in a ground line of the AC-DC converter 13. Specifically, the coil L2 is provided between a full-wave rectifier circuit 20 and an electrode of an NMOS transistor 23 on a low potential side (that is, a source electrode).

In the configuration in which the coil L2 of the saturable inductor 22 is provided in the ground line (i.e., provided between the full-wave rectifier circuit 20 and the electrode of the NMOS transistor 23 on the low potential side (that is, the source electrode)), a large voltage is generated across the coil L2 when the inductor current IL is within the predetermined range. Accordingly, the above configuration can reduce the influence of noise more effectively than a configuration in which a shunt resistor is provided in the ground line and is used to detect that the inductor current IL reaches the predetermined value. Further, since the coil L2 is inductance, current loss does not occur.

Further, a resistor 29 may be provided as a shunt resistor between the coil L2 and the electrode of the NMOS transistor 23 on the low potential side. In the case where the resistor 29 is provided, a power factor correction IC 30 may use the resistor 29 for a protection function such as detecting that the inductor current IL to flow into the NMOS transistor 23 is an overcurrent.

Further, if the resistor 29 is used to detect that the inductor current IL reaches the predetermined value, the voltage generated across the resistor 29 is several millivolts to several tens of millivolts and is easily influenced by noise. On the other hand, if the resistor 29 is used to detect an overcurrent, the current value of the overcurrent is larger than the predetermined value. Thus, the voltage generated across the resistor 29 is not easily influenced by noise.

In addition, the power factor correction IC 30 includes a terminal A0 coupled to a coupling point between the coil L2 and the full-wave rectifier circuit 20 and a terminal A1 coupled to a coupling point between the coil L2 and the electrode of the NMOS transistor 23 on the low potential side in order to detect the voltage generated across the coil L2.

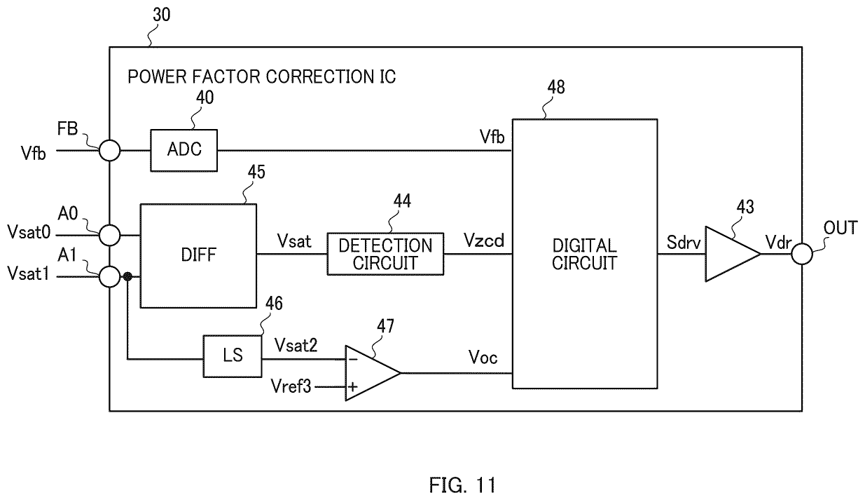

FIG. 11 is a diagram illustrating an example configuration of the power factor correction IC 30. The power factor correction IC 30 switches the NMOS transistor 23. The power factor correction IC 30 includes an analog-to-digital converter circuit (ADC) 40, a driver circuit 43, a detection circuit 44, a differential amplifier circuit 45, a level shifter circuit (LS) 46, a comparator 47, and a digital circuit 48.

The differential amplifier circuit 45 amplifies the voltage generated across the coil L2 based on the voltages applied to the terminals A0 and A1 and thereby outputs the voltage Vsat. The detection circuit 44 compares the voltage Vsat and the reference voltage Vref2 and detects that the inductor current IL reaches the predetermined value.

The level shifter circuit 46 level-shifts a voltage Vsat1 to a positive voltage and outputs a voltage Vsat2.

The comparator 47 compares the voltage Vsat2 and a reference voltage Vref3 and outputs a high signal Voc when the voltage Vsat2 is lower than the reference voltage Vref3. On the other hand, the comparator 47 outputs a low signal Voc when the voltage Vsat2 is higher than the reference voltage Vref3.

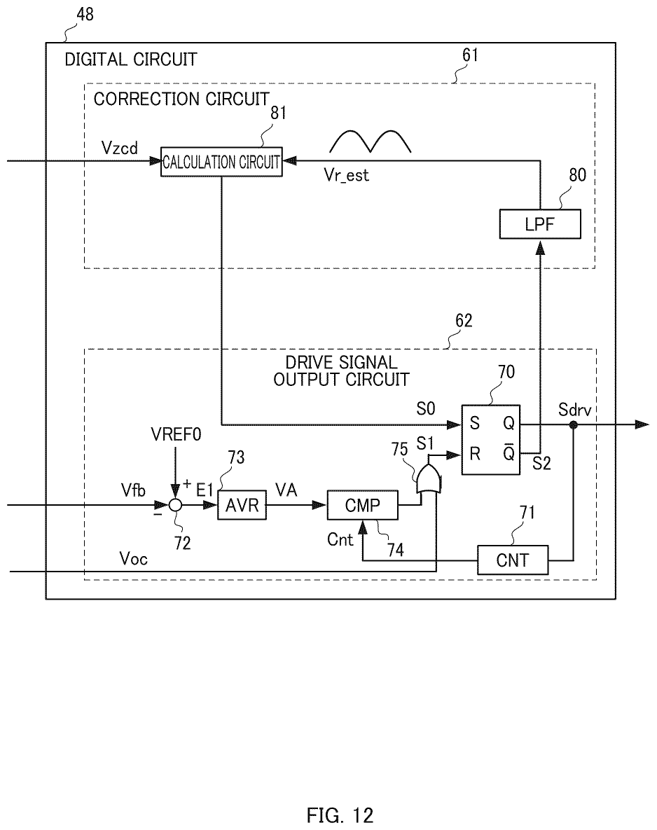

FIG. 12 is a diagram illustrating an example configuration of the digital circuit 48. The digital circuit 48 outputs a drive signal Sdrv for switching the NMOS transistor 23 based on the feedback voltage Vfb, the signal Vzcd, and the signal Voc.

Specifically, the digital circuit 48 outputs the drive signal Sdrv to turn on the NMOS transistor 23 in response to the detection circuit 44 detecting that the inductor current IL reaches the predetermined value. Then, the digital circuit 48 outputs the drive signal Sdrv to turn off the NMOS transistor 23 in response to the time period corresponding to the output voltage (that is, the feedback voltage Vfb) having elapsed. The digital circuit 48 outputs the drive signal Sdrv to turning off the NMOS transistor 23 in response to the comparator 47 outputting the high signal Voc. The digital circuit 48 includes a drive signal output circuit 62 and a correction circuit 61.

The drive signal output circuit 62 outputs the drive signal Sdrv to switch the NMOS transistor 23 based on the feedback voltage Vfb and the signals S0 and Voc. Specifically, the drive signal output circuit 62 outputs the drive signal Sdrv to turn on the NMOS transistor 23 in response to the high signal S0 being inputted to the drive signal output circuit 62.

Then, the drive signal output circuit 62 outputs the drive signal Sdrv to turn off the NMOS transistor 23 in response to the time period corresponding to the output voltage (that is, the feedback voltage Vfb) having elapsed. The drive signal output circuit 62 outputs the drive signal Sdrv to turn off the NMOS transistor 23 in response to the comparator 47 outputting the high signal Voc.

The drive signal output circuit 62 includes an SR flip-flop 70, a counter 71, a subtractor 72, a voltage regulator (AVR) 73, a comparator 74, and an OR circuit 75.

The OR circuit 75 performs a logical OR operation on the output signal of the comparator 74 and the signal Voc, and outputs the result to the SR flip-flop 70. The SR flip-flop 70 outputs the drive signal Sdrv to turn off the NMOS transistor 23 in response to the OR circuit 75 outputting the high signal S1.

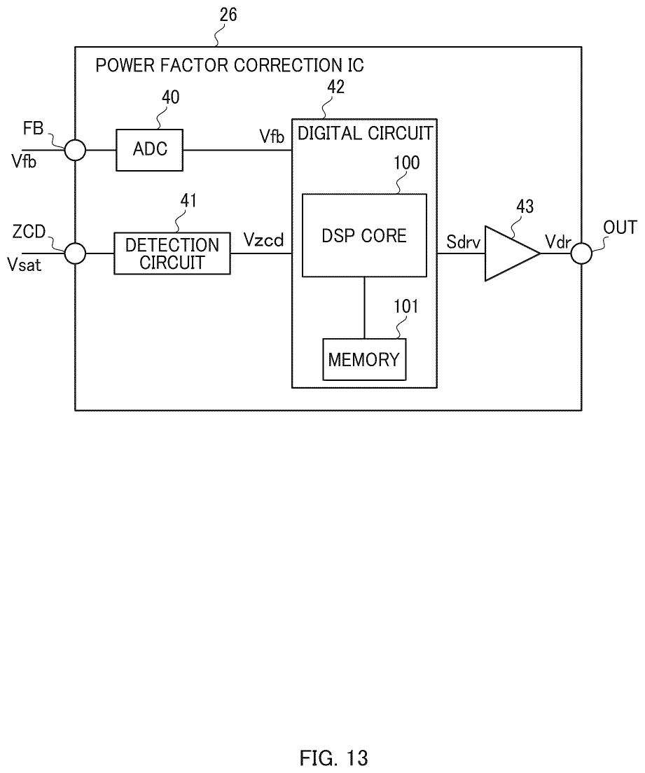

FIG. 13 is a diagram illustrating an example of an embodiment using a DSP. The digital circuit 42 includes a DSP core 100 and a memory 101 that stores a program to be executed by the DSP core 100 and various kinds of information. Executing the program, the DSP core 100 enables the digital circuit 42 to implement various circuits and functional blocks such as an adder, a subtractor, a multiplier, a divider, a filter, and an amplifier circuit. The same applies to the digital circuit 48.

The digital circuit 42 or 48 may be implemented using a hardware logic circuit (i.e., wired logic) instead of the DSP core 100 and the memory 101. The digital circuit 42 or 48 may be implemented using a combination of wired logic and programmable logic.

When the DSP core 100 executes the program, the drive signal output circuit 60 corresponds to a drive signal output unit 60, the correction circuit 61 corresponds to a correction unit 61, and the drive signal output circuit 62 corresponds to a drive signal output unit 62.

Although the detection circuit 41 detects that the inductor current IL reaches the predetermined value, based on the voltage across the coil L3 in the above description, the detection circuit 41 may detect that the inductor current IL reaches the predetermined value, based on the voltage across the coupling point between the inductor L1 and the coil L2.

Further, the low-pass filter 80 generates the signal Vr_est in the above description. Instead, the signal Vr_est may be generated by dividing the input voltage Vrec.

Further, although the detection circuit 44 detects that the inductor current IL reaches the predetermined value, based on the difference between the voltages generated across the coils L3 and L4 in the above description, the detection circuit 44 may also detect that the inductor current IL reaches the predetermined value, based on the difference between the voltages respectively generated across the inductor L1 and the coil L2.

### Summary

The AC-DC converter 10 in this embodiment is described above. The AC-DC converter 10 includes the coil L2, and the power factor correction IC 26 includes the detection circuit 41 and the digital circuit 42. Thus, it is possible to provide a switching control circuit capable of accurately detecting a timing when the inductor current reaches a predetermined value.

Further, the AC-DC converter 10 includes the coil L3, and the detection circuit 41 detects that the inductor current IL reaches the predetermined value, based on the voltage across the coil L3. In this case, since the detection circuit 41 detects that the inductor current IL reaches the predetermined value, only based on the voltage generated across the coil L3, the power factor correction IC 26 can easily detect the voltage Vsat.

Further, the detection circuit 41 includes the reference voltage circuit 90 and the comparator 91. Thus, in the case where the phase angle of the input voltage Vrec is low, a higher reference voltage Vref1 than in the case where the phase angle of the input voltage Vrec is high can be used, and influence caused by noise is less likely to be received.

The detection circuit 44 detects that the inductor current IL reaches the predetermined value, based on the difference between the voltages generated across the inductor L1 and the coil L2. Thus, it is possible to detect that the inductor current IL reaches the predetermined value with the reference voltage Vref2 to be compared with the voltage Vsat being maintained at a predetermined level.

The AC-DC converter 12 includes the coil L4, and the detection circuit 44 detects that the inductor current IL reaches the predetermined value, based on the voltage across the coils L3 and L4 coupled in series. This makes it easier to design the power factor correction IC 26 because the voltage Vsat to be compared with the reference voltage Vref2 is lower than in the case where the inductor L1 and the coil L2 are used.

The coil L2 includes a first terminal configured to receive the voltage corresponding to the input voltage Vrec and a second terminal coupled to the inductor L1. This makes it easier to design the power factor correction IC 26 because the voltage generated across the coil L2 is the voltage obtained by division by the voltage divider circuit constituted by the inductor L1 and the coil L2.

The AC-DC converter 13 includes the full-wave rectifier circuit 20, and the coil L2 is provided between the full-wave rectifier circuit 20 and the electrode of the NMOS transistor 23 on the low potential side (that is, the source electrode). This makes it possible to provide a switching control circuit capable of accurately detecting a timing when the inductor current reaches a predetermined value.

The AC-DC converter 13 includes the resistor 29, and the digital circuit 42 outputs the drive signal Sdrv for switching the NMOS transistor 23, based on the inductor current IL flowing through the resistor 29. Thus, the resistor 29 is not used to detect that inductor current IL reaches the predetermined value, but is used, for example, to detect an overcurrent, and thus the voltage generated across the resistor 29 is less likely to be influenced by noise.

The digital circuit 42 includes the drive signal output circuit 60 and the correction circuit 61. This makes it possible to turn on the NMOS transistor 23 not at the timing when the detection circuit 41 detects that the inductor current IL reaches the predetermined value, but at the timing when the inductor current IL actually reaches the predetermined value.

The power factor correction IC 26 is suitable for use in the AC-DC converter 10.

The present disclosure is directed to provision of a switching control circuit capable of accurately detecting a timing when an inductor current reaches a predetermined value.

According to the present disclosure, it is possible to provide a switching control circuit capable of accurately detecting a timing when an inductor current reaches a predetermined value.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

What is claimed is:

1. A switching control circuit for a power supply circuit that generates an output voltage at a target level from an input voltage inputted thereto, the power supply circuit including
a first inductor configured to receive a voltage corresponding to an input voltage,
a transistor configured to control an inductor current flowing through the first inductor, and
a second inductor configured to have a current flowing therethrough,
the switching control circuit being configured to switch the transistor of the power supply circuit, the switching control circuit comprising:
a detection circuit configured to detect that the inductor current reaches a predetermined value, based on a voltage generated across the second inductor; and
a signal output circuit configured to
output a drive signal to turn on the transistor, in response to the detection circuit detecting that the inductor current reaches the predetermined value, and
output the drive signal to turn off the transistor, in response to a time period corresponding to the output voltage having elapsed,
the second inductor being configured to
be in an unsaturated state when the inductor current is within a predetermined range including the predetermined value, and
be in a saturated state when the inductor current is outside the predetermined range.

2. The switching control circuit according to claim 1, wherein
the power supply circuit further includes a third inductor magnetically coupled to the second inductor, and
the detection circuit detects that the inductor current reaches the predetermined value, based further on a voltage across the third inductor.

3. The switching control circuit according to claim 1, wherein
the detection circuit further includes
a reference voltage circuit configured to output a reference voltage indicating that the inductor current reaches the predetermined value, and
a comparator configured to detect that the inductor current reaches the predetermined value, based on the voltage generated across the second inductor and the reference voltage, and
the reference voltage circuit changes the reference voltage according to a voltage level of the input voltage.

4. The switching control circuit according to claim 2, wherein
the detection circuit detects that the inductor current reaches the predetermined value, based further on a difference between the voltage generated across the second inductor and a voltage generated across the first inductor.

5. The switching control circuit according to claim 4, wherein
the power supply circuit further includes a fourth inductor magnetically coupled to the first inductor, the third inductor and the fourth inductor being coupled in series, and
the detection circuit detects that the inductor current reaches the predetermined value, based on further a voltage across the third inductor and the fourth inductor coupled in series.

6. The switching control circuit according to claim 1, wherein
the second inductor further includes a first terminal configured to receive a voltage corresponding to the input voltage and a second terminal coupled to the first inductor.

7. The switching control circuit according to claim 1, wherein
the transistor has a low-potential-side electrode, and
the power supply circuit further includes a full-wave rectifier circuit configured to full-wave rectify the input voltage, and
the second inductor is provided between the full-wave rectifier circuit and the low-potential-side electrode of the transistor.

8. The switching control circuit according to claim 7, wherein
the power supply circuit further includes a resistor provided between the second inductor and the low-potential-side electrode of the transistor, and
the signal output circuit outputs the drive signal to switch the transistor, based on a current flowing through the resistor.

9. The switching control circuit according to claim 1, wherein
the signal output circuit further includes
a correction circuit configured to correct a result of detection of the detection circuit, based on a voltage level of the input voltage, and output a signal indicating a timing when the inductor current reaches the predetermined value, and
a drive signal output circuit configured to
output the drive signal to turn on the transistor upon receiving the signal indicating the timing, and
output the drive signal to turn off the transistor in response to the time period corresponding to the output voltage having elapsed.

10. The switching control circuit according to claim 9, wherein
the correction circuit further includes
a low-pass filter configured to output a level signal according to the voltage level of the input voltage, and
a calculation circuit configured to, in response to the second inductor entering the unsaturated state and the detection circuit detecting that the inductor current reaches the predetermined value,
correct the result of the detection of the detection circuit, based on an error calculated based on the level signal, and
output the signal indicating the timing when the inductor current reaches the predetermined value.

11. A power supply circuit configured to generate an output voltage at a target level from an input voltage inputted thereto, comprising:
a first inductor configured to receive a voltage corresponding to the input voltage;
a transistor configured to control an inductor current flowing through the first inductor;
a second inductor configured to have a current flowing therethrough;
a switching control circuit configured to switch the transistor, the switching control circuit including
a detection circuit configured to detect that the inductor current reaches a predetermined value, based on a voltage generated across the second inductor; and
a signal output circuit configured to
output a drive signal to turn on the transistor in response to the detection circuit detecting that the inductor current reaches the predetermined value, and
output the drive signal to turn off the transistor in response to a time period corresponding to the output voltage having elapsed,
the second inductor being configured to
be in an unsaturated state when the inductor current is within a predetermined range including the predetermined value, and
be in a saturated state when the inductor current is outside the predetermined range.
